(19) United States
(12) Patent Application Publication
(10) Pub. No.: US 2024/0115067 A1
(43) Pub. Date: Apr. 11, 2024

(54) LID BODY ASSEMBLY AND COOKING APPARATUS

(71) Applicant: FOSHAN SHUNDE MIDEA ELECTRICAL HEATING APPLIANCES MANUFACTURING CO., LTD., FOSHAN (CN)

(72) Inventors: Feilong LUO, FOSHAN (CN); Hanjie HU, FOSHAN (CN); Xiongwei GUO, FOSHAN (CN); Bowen ZHENG, FOSHAN (CN); Yi ZHOU, FOSHAN (CN); Yuehong QU, FOSHAN (CN)

(21) Appl. No.: 18/263,701

(22) PCT Filed: Dec. 20, 2021
(86) PCT No.: PCT/CN2021/139765

§ 371 Date: Jul. 31, 2023

(30) Foreign Application Priority Data
Apr. 27, 2021 (CN) 202110460780.8
Apr. 27, 2021 (CN) 202120887378.3

(51) Int. Cl. A47J 27/08

(52) U.S. Cl. CPC A47J 27/08

(57) ABSTRACT

Embodiments of the present application relate to the field of cooking devices. Disclosed are a lid body assembly and a cooking apparatus. The lid body assembly comprises a pot lid, an air blowing apparatus, and a check valve. The pot lid is used for covering a pot body having a cooking cavity to open and close the cooking cavity. The air blowing apparatus is arranged in the pot lid to blow air into the cooking cavity. The check valve is used for allowing airflow to flow from the air blowing apparatus to the cooking cavity in one direction.

### CROSS-REFERENCES TO RELATED APPLICATIONS

The present disclosure is a national phase application of International Application PCT/CN2021/139765, filed on Dec. 20, 2021, which claims priorities to Chinese Patent Application No. 202110460780.8 filed on Apr. 27, 2021 and Chinese Patent Application No. 202120887378.3 filed on Apr. 27, 2021, the entireties of which are herein incorporated by reference.

### FIELD

The disclosure belongs to the field of cooking devices, and in particular to a lid body assembly and a cooking apparatus.

### BACKGROUND

As an apparatus for cooking food, an electric cooker is provided with a circulation device in a related lid body of the electric cooker to discharge stale tastes of rice in the electric cooker. The circulation device is intended to introduce fresh air in the electric cooker to discharge steam in the electric cooker. A related circulation device controls air blowing in a complicated way.

### SUMMARY

In view of this, the disclosure provides a lid body assembly and a cooking apparatus, to solve a technical problem of simplifying control of air blowing in the lid body assembly.

Embodiments of the disclosure are implemented as follows. An embodiment of the disclosure provides a lid body assembly, including a pot lid, an air blowing device, and a check valve. The pot lid is configured to cover a pot body provided with a cooking cavity to open or close the cooking cavity. The air blowing device is arranged in the pot lid and configured to blow air into the cooking cavity. The check valve is configured to unidirectionally guide an airflow to flow from the air blowing device to the cooking cavity.

An embodiment of the disclosure further provides a cooking apparatus, including a pot body and the forgoing lid body assembly. The pot body is provided with a cooking cavity. The lid body assembly covers the pot body to open or close the cooking cavity, and the air blowing device of the lid body assembly is communicated with the cooking cavity to blow air into the cooking cavity and guide air out of the cooking cavity.

In a lid body assembly and a cooking apparatus provided by embodiments of the disclosure, the lid body assembly includes a pot lid, an air blowing device, and a check valve. The pot lid is configured to cover a pot body provided with a cooking cavity to open or close the cooking cavity. The air blowing device is arranged in the pot lid to blow air into the cooking cavity. The check valve is configured to unidirectionally guide an airflow to flow from the air blowing device to the cooking cavity. According to the disclosure, the check valve is arranged in the pot lid, thus during the air blowing device blowing fresh air into the cooking cavity, a circulation channel of the airflow may be enabled unidirectionally, and a risk of impacting the air blowing device by steam in the pot body is reduced, and controlling of air blowing is simplified by means of the check valve.

### BRIEF DESCRIPTION OF THE DRAWINGS

FIG. 1 is a schematic sectional view of a cooking apparatus according to an embodiment of the disclosure.

FIG. 2 is an enlarged view of part A in FIG. 1.

FIG. 3 is a schematic structural diagram of a check valve according to an embodiment of the disclosure.

FIG. 4 is a perspective view of a valve body according to an embodiment of the disclosure.

FIG. 5 is a perspective view of a check valve according to an embodiment of the disclosure.

FIG. 6 is a schematic structural diagram of a check valve according to another embodiment of the disclosure.

FIG. 7 is a top view of a check valve according to an embodiment of the disclosure.

FIG. 8 is a bottom view of a lid body assembly according to an embodiment of the disclosure.

FIG. 9 is a sectional view of a steam hole according to an embodiment of the disclosure.

FIG. 10 is a schematic view of air exchange of a cooking apparatus according to an embodiment of the disclosure.

FIG. 11 is a sectional view of FIG. 8 in a B-B direction.

FIG. 12 is a schematic structural diagram of another externalization assembly according to an embodiment of the disclosure.

FIG. 13 is a schematic structural diagram of a venting member according to an embodiment of the disclosure.

FIG. 14 is a schematic structural diagram of a sealing and isolation member according to an embodiment of the disclosure.

### DESCRIPTIONS OF REFERENCE NUMERALS

10. pot lid; 10a. cooking cavity; 11. surface lid; 11A. steam hole; 11B. first accommodation cavity; 111. steam valve cap; 12. inner lid; 12a. first channel; 12b. first through hole; 122. externalization assembly; 122A. second accommodation cavity; 1221. movement component; 1222. transparent lid body; 1223. shell; 123. first sealing member; 124. air guide component; 13. movable cover plate; 14. venting member; 141. steam channel; 15. sealing and isolation member; 15A. first opening; 15B. second opening; 151. first rib; 152. second rib; 16. steam valve cap; 2. pot body; 20. air blowing device; 21. airflow generation device; 22. air inlet device; 30. check valve; 31. valve seat; 311. seat body; 312. fixed part; 312a. recessed part; 312b. second sealing member; 31a. second through hole; 32. valve body; 321. connection part; 322. movable part; 322a. valve plate; 322b. skirt; S1. first mounting region; L1. length of pot lid; L2. width of pot lid; D1. width of first mounting region; D2. length of first mounting region; d. distance between edge of externalization assembly and edge of steam hole.

### DETAILED DESCRIPTION OF THE DISCLOSURE

In order to make the embodiments of the disclosure clearer, the disclosure is further described in detail below with reference to the accompanying drawings and embodiments. It should be understood that specific embodiments described here are only intended to explain the disclosure, rather than limiting the disclosure.

Various embodiments may be combined in any appropriate ways without contradiction, for example, different embodiments may be formed through different combinations of embodiments. In order to avoid unnecessary repetition, various possible combinations of various specific features in the disclosure will not be elaborated.

Terms “first\second\ . . . ” involved in following descriptions are only intended to distinguish different objects and do not indicate that there are similarities or connections among the objects. It should be understood that related orientation descriptions “above”, “blow”, “outside” and “inside” are all orientations in normal usage states, and that “left” and “right” directions indicate left and right directions shown in a specific corresponding schematic view, which may be or may not be left and right directions in normal usage states.

It should be noted that terms “includes”, “including” or any other variants thereof are intended to encompass non-exclusive inclusion, such that a process, method, article or apparatus including a series of elements, includes not only those elements, but also other elements which are not explicitly listed, or elements which are inherent to the process, method, article or apparatus. Without further limitations, an element defined by a phrase “including a . . . ” does not preclude presence of additional identical elements in the process, method, article or apparatus including that element.

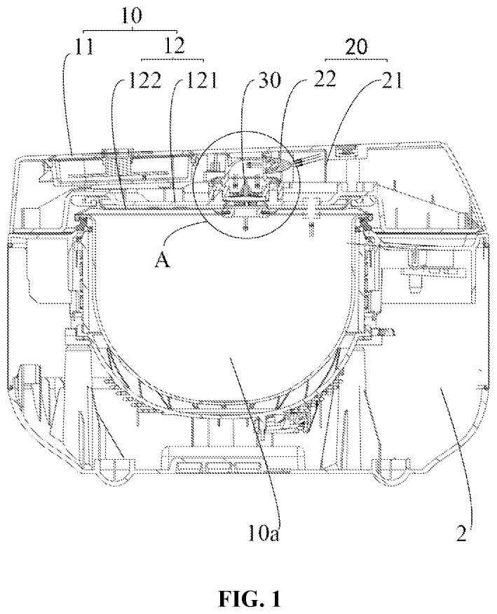

In the following descriptions, inlet and outlet of each component are explained with reference to a direction of an airflow indicated by arrows in FIG. 1. Specifically, a direction of the arrows shown in FIG. 1 indicates a flow direction of an airflow entering a cooking apparatus. A part of a component with which the entering airflow is in contact first may be understood as an inlet end of the component, and correspondingly, a part of the component from which the airflow exits finally may be understood as an outlet end of the component. For example, an inlet end of an air inlet device may be understood as an end where the entering airflow is in contact with the air inlet device first, and the entering airflow enters the air inlet device through the inlet end and exits the air inlet device from an outlet end of the air inlet device.

The disclosure provides a lid body assembly and a cooking apparatus. The lid body assembly may be applied to cooking apparatuses such as an electric cooker, an electric pressure cooker, a stewpot, a soybean milk maker, or the like. It should be noted that types of application scenarios of the disclosure do not limit the lid body assembly of the disclosure.

The following descriptions take the lid body assembly applied to the electric cooker as an example. As shown in FIG. 1, the lid body assembly according to an embodiment of the disclosure includes a pot lid 10, an air blowing device 20 and a check valve 30. The pot lid 10 is configured to cover a pot body 2 provided with a cooking cavity 10a to open or close the cooking cavity 10a. For example, in a cooking state of the electric cooker, rice and water may be contained in the cooking cavity 10a, and the pot lid 10 covers the pot body 2 to close the cooking cavity 10a; and in a state where cooking is completed or is not performed, the pot lid 10 may be opened to open the cooking cavity 10a. The air blowing device 20 is arranged in the pot lid 10 and may blow air into the cooking cavity 10a. For example, in an operation state of the electric cooker, external fresh air is blown by the air blowing device 20 into the cooking cavity 10a. Due to introduction of the air, an intensity of pressure of air inside the pot body 2 is greater than an intensity of pressure of air outside the pot body 2, and the pressure difference is used to discharge at least a part of air in the cooking cavity 10a out of the pot body 2, to generate an airflow to perform air exchange of the cooking cavity 10a, and contents of odorous substances in the cooking cavity 10a are reduced, facilitating discharging stale substances released by food ingredients such as rice or the like in the pot body 2 in time, thus improving cooking aromas of the food ingredients. The check valve 30 may be a component guiding air, a liquid or an air-liquid mixture unidirectionally. According to the embodiment of the disclosure, an airflow flowing from the air blowing device 20 to the cooking cavity 10a is guided unidirectionally by the check valve 30, and an airflow may flow from outside of the electric cooker to the cooking cavity 10a through the check valve 30, but an airflow from the cooking cavity 10a to the check valve 30 cannot flow to outside of the electric cooker. Air from the cooking cavity 10a to outside of the electric cooker needs to be discharged out of the electric cooker through a steam hole 11A.

According to the embodiment of the disclosure, the check valve is arranged in the pot lid, thus during the air blowing device blowing fresh air into the cooking cavity, a circulation channel through which the airflow flows into the cooking cavity may be enabled unidirectionally, and air inflow is separated from air outflow, a risk of impacting the air blowing device by steam in the pot body is reduced, and controlling of air blowing is simplified by means of the check valve.

In some embodiments, as shown in FIG. 1, the air blowing device 20 includes an airflow generation device 21 and an air inlet device 22. The airflow generation device 21 is configured to generate an airflow. In the embodiments of the disclosure, the airflow generation device 21 includes, but is not limited to, a fan and an air pump. The air inlet device 22 is connected to the airflow generation device 21 to introduce the airflow generated by the airflow generation device 21 into the cooking cavity 10a; and the air inlet device 22 is connected to the check valve 30 to enable the airflow in the air inlet device 22 to flow to the cooking cavity 10a unidirectionally. In an embodiment, the check valve may be arranged at a connection position of the air inlet device and the airflow generation device, and the connection position includes, but is not limited to, a position close to a junction of the air inlet device and the airflow generation device, and specifically, the connection position may be outside the junction of the air inlet device, or may be inside the junction. The check valve may also be arranged at a connection position of the air inlet device and the cooking cavity, and the connection position includes, but is not limited to, a position close to a junction of the air inlet device and the cooking cavity, and specifically, the connection position may be outside the junction of the air inlet device, or may be inside the junction. The check valve may also be arranged in the air inlet device.

In some embodiments, as shown in FIG. 1, the check valve 30 is arranged at an outlet end of the air inlet device 22. The outlet end of the air inlet device 22 may be close to a junction position of the air inlet device 22 and the cooking cavity 10a, or may be an inner side of the cooking cavity 10a proximate to the air inlet device 22. According to the embodiments of the disclosure, the check valve is arranged at the outlet end of the air inlet device, which is easy to be mounted and by which the airflow entering the cooking cavity may be accurately controlled, and stale air in the cooking cavity does not enter the air inlet device, and air inflow and air outflow are independent of each other and do not interfere with each other, thus improving air exchange efficiency in the cooking cavity.

In some embodiments, as shown in FIG. 1, the pot lid 10 includes a surface lid 11 and an inner lid 12. The inner lid 12 and the surface lid 11 may be fixedly connected to each other directly. Or, the surface lid 11 and the inner lid 12 may be fixedly connected to each other indirectly. The air inlet device 22 is mounted on the surface lid 11, in an embodiment, the air inlet device 22 may be fixedly mounted on the surface lid 11 as an independent component; and a cavity with two end openings may also be directly arranged on the surface lid 11 to be directly used as the air inlet device 22. The check valve 30 is fixed on the inner lid 12, and connection of the check valve 30 and the inner lid 12 includes, but is not limited to, direct fixed connection such as snap-in connection or the like. Specifically, the check valve may be provided with a related snap-in groove, the inner lid is provided with a related snap-in part, and through assembly of the snap-in groove on the check valve and the snap-in part on the inner lid, the check valve is assembled on a side of the inner lid, and a through hole communicated with the cooking cavity is arranged at a position on the inner lid opposite to the check valve. In other embodiments, the inner lid may be provided with a through hole to mount the check valve therein, and the check valve may be fixed in the through hole in a threaded manner or in other manners. The embodiments of the disclosure do not limit specific connection of the check valve and the inner lid. In the embodiments of the disclosure, the pot lid is divided into the surface lid and the inner lid, and the air inlet device and the check valve may be separately assembled on two components, their assembly processes are more flexible, and replacement, disassembly and assembly of the components are convenient, saving maintenance cost of product.

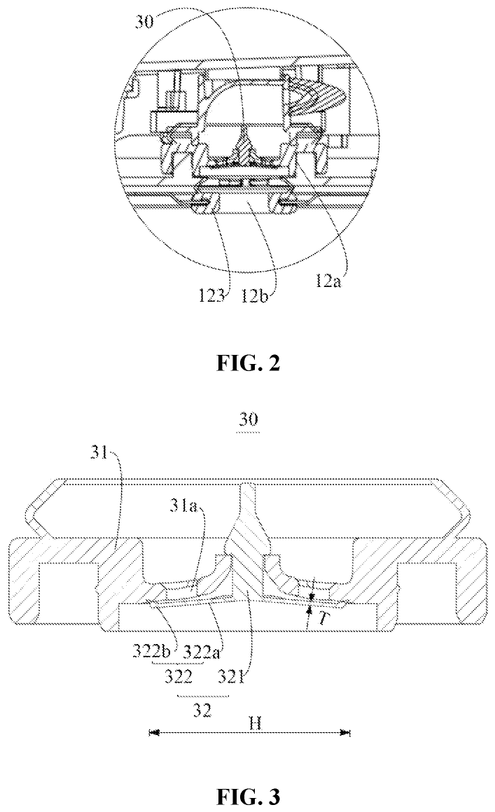

In some embodiments, as shown in FIG. 1 and FIG. 2, the pot lid 10 includes a surface lid 11, an inner lid 12, a movable cover plate 13 and a first sealing member 123, and the movable cover plate 13 may be fixedly connected to the inner lid 12 in a detachable way. The inner lid 12 is adjacent to and connected to the surface lid 11, the inner lid 12 is close to the surface lid 11 relative to the movable cover plate 13, the movable cover plate 13 is arranged on a side of the inner lid 12 away from the surface lid 11, and the inner lid 12 is provided with a first channel 12a penetrating through opposite ends of the inner lid 12. The movable cover plate 13 is connected to the inner lid 12 and provided with a first through hole 12b communicated with the first channel 12a, such that the airflow in the air inlet device 22 may flow into the cooking cavity 10a from the inner lid 12 and the first through hole 12b in the movable cover plate 13. The first sealing member 123 is arranged between the inner lid 12 and the movable cover plate 13 around the first through hole 12b. The first sealing member 123 may be fittingly arranged on an inner wall of the first through hole 12b, and protrudes from a surface of the inner lid 12 in an extension direction of the first through hole 12b, such that the airflow flowing into the movable cover plate 13 from the inner lid 12 is limited in the first through hole 12b, to improve tightness of the inner lid and the movable cover plate, and reduce air in the air inlet device entering other regions inside the pot lid other than the air inlet device by passing through a gap between the inner lid and the movable cover plate, to reduce possibility of failure.

As shown in FIG. 1 and FIG. 2, in the embodiments of the disclosure, the check valve 30 is at least partially arranged in the first channel 12a, or the check valve 30 is at least partially arranged in the first through hole 12b. Specifically, the check valve 30 may be fixed in the first channel 12a, the airflow generation device 21 allows the airflow to flow from the air inlet device 22 to the check valve 30, and the airflow enters the cooking cavity 10a from the first through hole 12b after passing through the check valve 30; or, the check valve 30 may be fixed in the first through hole 12b, and the check valve 30 may partially protrude from the first through hole 12b since the movable cover plate 13 has a thickness limitation. According to the embodiments of the disclosure, by providing the inner lid 12 and the movable cover plate 13 such that the inner lid is detachably connected to the movable cover plate, the movable cover plate may be cleaned directly and separately after cooking, to reduce food residues left on the movable cover plate, and reducing risk of odors generated by deposition of the residues.

In some embodiments, as shown in FIG. 3, the check valve 30 includes a valve seat 31 and a valve body 32. With reference to FIG. 1, the valve seat 31 is provided with a second through hole 31a communicated with the air inlet device 22, and air in the air inlet device 22 may flow from the second through hole 31a to the cooking cavity 10a. The valve body is connected to the valve seat. Specifically, the whole valve body may be movably connected to the valve seat, and in a state where air flows from the air inlet device to the cooking cavity, airflow acts on the valve body, resulting in change of position of the valve body relative to the valve seat, and the valve body moves from a position of blocking the second through hole to a position of opening the second through hole; and in a state where no airflow flows from the air inlet device to the cooking cavity, the valve body is reset to the position of blocking the second through hole by means of a related elastic reset component, to play a role of unidirectional guidance. Or, the valve body may be partially fixedly connected to the valve seat, and in a state where no airflow flows from the air inlet device to the cooking cavity, the valve body is at least partially in contact with the second through hole, and the second through hole is in a closed state; in a state where air flows from the air inlet device to the cooking cavity, airflow acts on a part of the valve body which is not in a direct connection relationship with the valve seat, and the valve body is partially away from the second through hole to open the second through hole by the valve body; and in a state where no airflow flows from the air inlet device to the cooking cavity, the valve body restores from deformation through its own elasticity and is reset to the position of blocking the second through hole, to achieve an effect of unidirectional guidance too. According to the embodiments of the disclosure, by providing a structure in which the relative position of the valve body and the second through hole in the valve seat may be changed and reset, automatic on of a unidirectional airflow from the air inlet device to the cooking cavity and automatic off of a unidirectional airflow from the cooking cavity to the air inlet device may be achieved, and controlling of blowing air into the inner lid is simplified, processing is convenient, and cost is low.

In some embodiments, as shown in FIG. 3, the check valve 30 is at least partially arranged in the first channel 12a, the valve seat 31 is fixedly connected to the inner lid 12, and the valve body 32 is connected to the valve seat 31. In another embodiment, the check valve is at least partially arranged in the first through hole, the valve seat is connected to the movable cover plate, and the valve body is connected to the valve seat, in which the valve body may be partially arranged in the first channel.

In some embodiments, as shown in FIG. 3, the valve body 32 includes a connection part 321 and a movable part 322. The connection part 321 is configured to penetrate through the valve seat 31 and connected to the valve seat 31. In an embodiment, the connection part 321 may be fixedly connected to the valve seat 31 directly, or, the connection part 321 may be fixed to the valve seat 31 in a snap-in manner. Specifically, with reference to FIG. 3, a through hole penetrating through the valve seat 31 may be arranged at a center of the valve seat 31, a side wall of the connection part 321 is provided with a recessed part adapted to the through hole, and the connection part 321 passes through the through hole and is connected to the valve seat 31 by means of the recessed part in a snap-in manner. The movable part 322 is arranged around the connection part 321 and shields the second through hole 31a, here “around” may mean that the movable part 322 is configured to extend around by taking the connection part 321 as a center. In case that no airflow passes through the check valve 30, a side of the movable part 322 abuts against an end of the second through hole 31a, such that the airflow in the cooking cavity cannot flow from the second through hole 31a to the air inlet device. In case that the airflow flows from the air inlet device to the cooking cavity, airflow passing through the second through hole 31a acts on a surface of the movable part 322, and the surface of the movable part 322 deforms due to uneven stress, such that the movable part 322 is away from the second through hole 31a, to open the second through hole 31a. According to the embodiments of the disclosure, by means of deformation of the movable part, the movable part may automatically open or close the second through hole when it is acted or not acted by airflow.

In some embodiments, as shown in FIG. 3, may be thickness T of the movable part 322 is 0.3 to 1 mm, which is beneficial for the movable part to fit to the second through hole in the absence of airflow, and for the movable part to automatically deform in the presence of airflow and have a thickness restored from deformation.

In some embodiments, as shown in FIG. 3, may be width H of the movable part 322 is 8 to 35 mm. In the disclosure, the width of the movable part may be a linear distance between two farthest points at an edge of the movable part 322. The movable part may be of a regular rectangle or circular shape, or, the movable part may be of an irregular geometrical shape. Configuring the movable part within the above width range may be beneficial for configuration of width of an airflow channel in the check valve, and may be beneficial for mounting the same on the pot lid.

In some embodiments, as shown in FIG. 3, may be hardness of the movable part 322 is 20 to 50 HB. In an embodiment, the hardness of the movable part may be set according to a pressure value of airflow. When a material within the above hardness range is selected for the movable part, it is beneficial for the movable part to deform and move under action of the airflow, such that switching between two operation states of opening and closing the airflow channel is completed, and operation effectiveness of the movable part is improved.

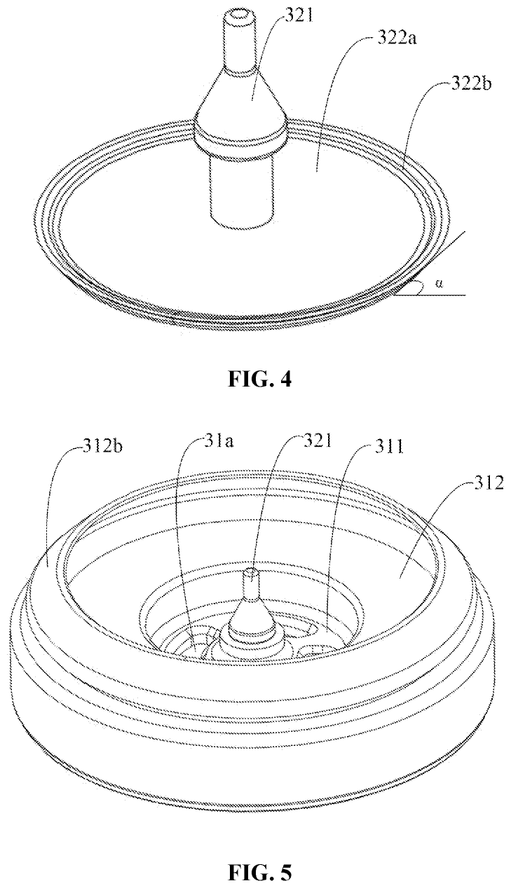

In some embodiments, as shown in FIG. 4, the movable part 322 includes a valve plate 322a and a skirt 322b. The valve plate 322a is fixed at an end of the connection part 321 and surround the connection part 321, the valve plate 322a may be arranged in a circular shape, and the connection part 321 is connected to a circular center of the valve plate 322a. In other embodiments, the valve plate 322a may be arranged in other shapes. With reference to FIG. 3, the valve plate 322a is configured to shield the second through hole 31a. The skirt 322b shown in FIG. 4 is arranged at an edge of the valve plate 322a. In a state where airflow flows from the second through hole 31a, the airflow acts on the valve plate 322a, the valve plate 322a deforms due to stress, and a position where the valve plate 322a is opposite to the second through hole 31a bears the greatest stress. Therefore, the valve plate 322a at a position close to the second through hole 31a is away from the second through hole 31a, and the skirt 322b is driven to be not in contact with the valve seat 31. In case that no airflow passes through the second through hole 31a, the valve plate 322a fits to the second through hole 31a, and the skirt 322b is in contact with the valve seat 31. Specifically, with reference to FIG. 3 and FIG. 4, a sectional area of the skirt 322b decreases from an end in contact with the valve plate 322a to another end in contact with the valve seat 31, then contact between the skirt 322b and the valve seat 31 may be approximately regarded as linear contact, and sealing between the skirt and the valve seat may be regarded as linear sealing. The linear sealing has higher effectiveness and reliability compared to surface sealing, and a sealing effect of the movable part in the absence of airflow may be improved, and a risk of airflow leakage from the cooking cavity to the air inlet device is reduced.

In some embodiments, as shown in FIG. 4, an included angle α between an extension direction of the skirt 322b and an extension direction of the valve plate 322a is greater than a preset value, the preset value may be 0 to 10°, and the included angle α between the extension direction of the skirt 322b and the extension direction of the valve plate 322a may be set to 10° to 90°. Specifically, the included angle α between the extension direction of the skirt 322b and the extension direction of the valve plate 322a may be set to 45°. According to the embodiments of the disclosure, by arranging the extension direction of the skirt 322b and the extension direction of the valve plate 322a at a set angle, the skirt may block and seal a gap between the valve plate and the valve seat.

In some embodiments, as shown in FIG. 5, the valve seat 31 includes a seat body 311 and a fixed part 312. The seat body 311 and the fixed part 312 may be integrally processed and formed, or may be separate components and fixedly connected to each other. The seat body 311 is provided with the second through hole 31a, the connection part 321 of the valve body penetrates through the seat body 311, the valve plate 322a of the valve body 32 is located on a side of the seat body 311 away from the surface lid (a lower side shown in FIG. 3). With reference to 2, the skirt 322b is close to the seat body 311 compared to the valve plate 322a, here “close to” may mean that a distance between the skirt 322b and the seat body 311 is less than a distance between the valve plate 322a and the seat body 311. The skirt 322b may be in tight contact with the seat body 311 in a state where no air flows in the second through hole 31a. The fixed part 312 is arranged at an edge of the seat body 311, here “edge” may mean that the fixed part 312 is located within a region close to a boundary position. The fixed part 312 is configured to be fixedly connected to the inner lid, or the fixed part is configured to be fixedly connected to the movable cover plate. “fixedly connected” may be direct fixed connection, or may be indirect fixed connection by means of other components.

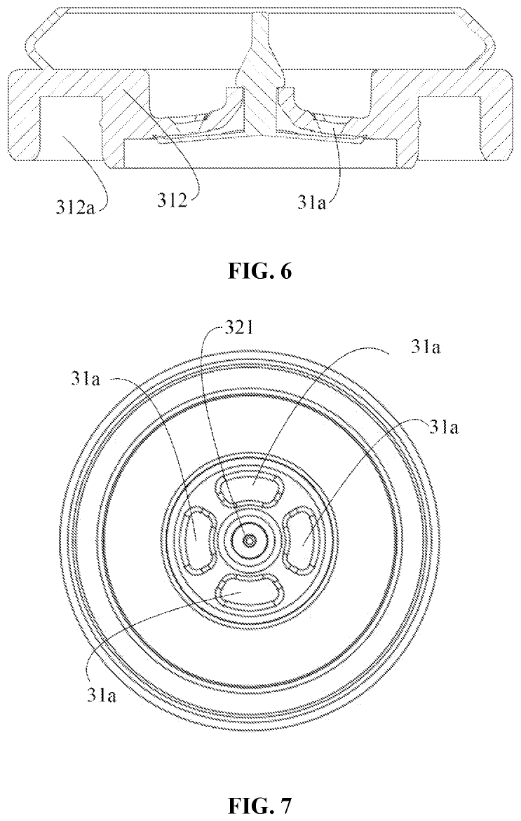

In some embodiments, as shown in FIG. 6, the fixed part 312 is provided with a recessed part 312a assembled with the inner lid or the movable cover plate, the inner lid or the movable cover plate is provided with a protrusion adapted to the recessed part 312a, and the recessed part 312a of the fixed part 312 is assembled with the protrusion to form a detachable fixed connection.

In some embodiments, as shown in FIG. 5, the fixed part 312 is provided with a second sealing member 312b forming a seal with the surface lid. In an embodiment, the second sealing part 312b is arranged in a flexible arc-shaped structure with a concave surface facing toward the center of the valve seat 31. According to the embodiments of the disclosure, by providing the second sealing member, it may block a mounting gap between the surface lid and a fixed member, to reduce a risk of damaging other components caused by airflow leakage to other positions in the lid body.

In some embodiments, as shown in FIG. 6, a sectional area of the second through hole 31a decreases in a direction from the surface lid to the inner lid (a direction from top to bottom shown in FIG. 6). It may be understood that a sectional area of a through hole is an area of a cross section perpendicular to a direction (including an axis direction of the through hole) of arrangement of the through hole, and size of the sectional area may also be measured by size of a hole diameter of the through hole. Specifically, a hole diameter of the second through hole 31a decreases in the direction from the surface lid to the inner lid. In the embodiments of the disclosure, the sectional area of the second through hole 31a decreases, and an air pressure of airflow flowing from the surface lid to the inner lid is increased, and effectiveness and efficiency of opening the valve plate are improved.

In some embodiments, as shown in FIG. 7, a plurality of second through holes 31a may be provided, arranged around the connection part 321, and arranged in a direction close to the edge of the movable part, such that air flowing in the second through holes may act on a position close to the edge of the movable part, to make the movable part deformed more easily. In other embodiments, the second through holes may be provided in a form of holes at a closed ring arranged around the connection part in a circle.

In some embodiments, the pot lid 10 is provided with a first mounting region S1, in which a steam hole 11A discharging steam is arranged. Specifically, the pot lid 10 may be divided into a plurality of functional regions according to actual requirements. As an example, the pot lid 10 may be provided with a first mounting region S1 and an operation panel control region S2, and as shown in FIG. 9, a part of the pot lid 10 in the first mounting region S1 may be directly recessed toward a cavity to form a steam hole 11A communicated with an external environment, and the steam hole 11A may be used as a steam channel to discharge steam generated in the pot body 2 of the cooking apparatus to the external environment. Specific forms for discharging steam may be set flexibly. In an embodiment, the steam hole 11A may extend to the cooking cavity 10a by directly passing through the inner lid, and steam generated in the cooking cavity 10a may be directly discharged to outside through the steam hole 11A. In an embodiment a connection tube may also be arranged at an end of the steam hole 11A close to the cooking cavity 10a, and the connecting tube is led to the cooking cavity 10a. That is, steam may be directly in contact with a wall surface of the steam hole 11A. In an embodiment, steam may not be directly in contact with the wall surface of the steam hole 11A. For example, a steam valve as an independent component may be arranged in the steam hole 11A, and steam in the cooking cavity is discharged through the steam valve. The operation panel control region S2 may be used to provide a display panel assembly and/or a control button, or the like thereon, and a user may perform, in the region, a series of operations such as selection, switching, activation and deactivation of functions, or the like. Function of each region is clearer through block division.

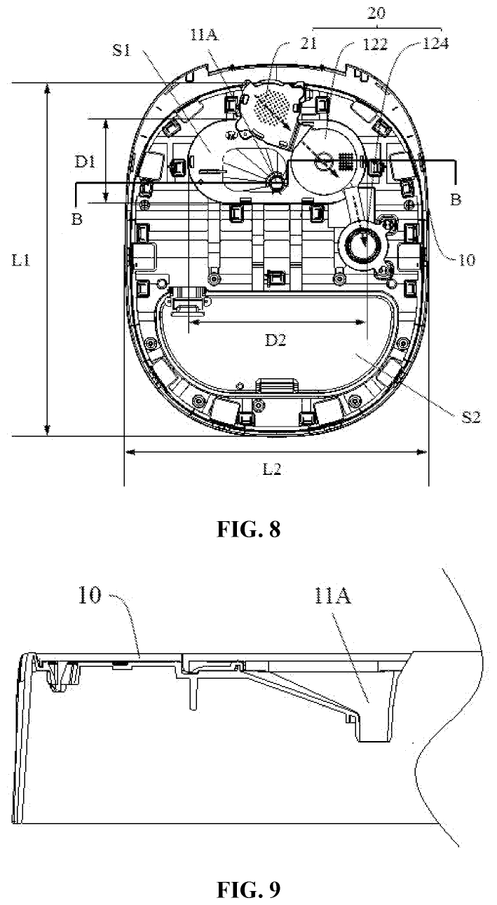

As shown in FIG. 8, the operation panel control region S2 and the first mounting region S1 may be spaced by a preset distance, and the operation region is kept at a distance from a flow region of airflow. As an example, in a flip-top cooking apparatus, the lid body assembly is rotatably connected to the pot body 2 by means of a hinge assembly, then the first mounting region S1 may be arranged at a position close to the hinge assembly, and the operation panel control region S2 may be arranged at a position away from the hinge assembly. In a state of normal usage, the hinge assembly is located at the rear of the cooking apparatus (an upper position shown in FIG. 8), and the user is located in front of the cooking apparatus (a lower position shown in FIG. 8). That is, the first mounting region S1 may be arranged close to the rear of the pot lid 10, and the operation panel control region S2 may be arranged close to the front of the pot lid 10. In this way, the operation panel control region S2 is closest to the user's operation range and facilitates the user to operate in the region, and the first mounting region S1 is far away from the user, and a risk of scalding the user by steam coming out of the first mounting region S1 may be effectively reduced.

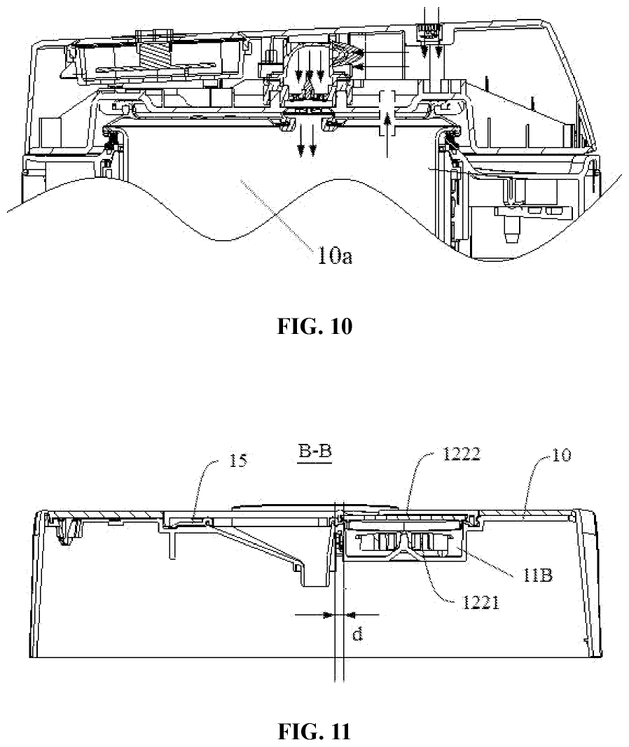

It may be understood that after cereals such as rice or the like are hulled, surfaces thereof may be oxidized and stale substances are generated. Taking rice as an example, surfaces of the hulled rice are oxidized to form stale rice, stale substances may be released in a form of air in a cooking process of the stale rice, causing the cooked rice to be stale and has a poor taste. As shown in FIG. 10, the cooking apparatus may be provided with an air blowing device. The air blowing device may be a component with a function of blowing air into the cooking cavity 10a, that is, the air blowing device may continuously introduce airflow in the external environment into the cooking cavity 10a, and under action of a pressure difference, at least a part of air in the cooking cavity 10a may be discharged to the external environment (arrows in FIG. 10 indicate a flow path of the airflow) through a steam channel. In this way, at least a part of the stale air originally in the cooking cavity 10a may be replaced with fresh air entered the cooking cavity 10a, and replacement of air in the cooking cavity 10a, i.e., air exchange, may be achieved, to reduce stale odors of the rice, achieving effects of removing stale odors and generating aromas, and improving edible taste of the rice. In an embodiment, the air blowing device may be a component with a function of withdrawing air from the cooking cavity 10a, continuously withdraws and discharges air in the cooking cavity 10a to the external environment, and the cooking apparatus may be provided with an air inlet communicated with the external environment, and air in the external environment may be enter the cooking cavity 10a as a supplement through the air inlet, and an air exchange effect may also be achieved in this way.

Since the airflow generation device 21 is in a cavity, in an operation state of the cooking apparatus, it is difficult for the user to determine whether the airflow generation device 21 is operating or operates normally, that is, it is difficult for the user to determine whether the cooking apparatus is performing an air exchange operation or performs air exchange normally. When the user opens the lid body assembly in an air exchange state, the effect of removing stale odors may be affected. An externalization assembly 122 may be provided to display an operation state of the airflow generation device 21, and the user may know, by observing the externalization assembly 122, whether the airflow generation device 21 is operating or operates normally. The externalization assembly 122 may include a display component with an electronic display function, and may be electrically connected to the airflow generation device 21; or, the externalization assembly 122 may be a mechanical movable component, and the operation state of the airflow generation device 21 is determined by a movement state of the component.

As shown in FIG. 8, the externalization assembly 122 is configured to display the airflow and arranged in the first mounting region S1; and an air guide component 124 is configured to guide the airflow out of the pot lid 10. Both ends of the externalization assembly 122 are connected to the airflow generation device 21 and the air guide component 124 respectively. Since the air guide component 124 is communicated with the cooking cavity 10a, steam from the cooking cavity 10a may form condensed water in the air guide component 124, the externalization assembly 122 is arranged between the airflow generation device 21 and the air guide component 124, and through separation of the externalization assembly 122, influence of the condensed water on the airflow generation device 21 may be effectively reduced, and operation stability and reliability of the air blowing device 20 may be improved.

As shown in FIG. 8, the steam hole 11A discharging steam and the airflow generation device 21 are arranged away from each other, and influence of high-temperature steam discharged from the steam hole 11A on the airflow generation device 21 may be effectively reduced.

As shown in FIG. 8, the externalization assembly 122 is arranged in the first mounting region S1. Specifically, the externalization assembly 122 is connected to the pot lid 10. The externalization assembly 122 may be a component completely independent of the pot lid 10, or may be a component partially formed from the pot lid 10. The user may determine the operation state of the airflow generation device 21, i.e., an air exchange operation state of the cooking apparatus directly by observing the first mounting region S1. Furthermore, the externalization assembly 122 is arranged in the first mounting region S1, and the steam hole 11A discharging steam and the externalization assembly 122 are gathered in a region, and structural arrangement is relatively compact. Then, the first mounting region S1 may be used as an observation region of the pot lid 10, and the user may observe steam discharging condition and the air exchange operation state of the cooking apparatus easily and collectively in the observation region. In this way, the user does not need to search positions of a steam outlet and the externalization assembly 122 in a whole region where the pot lid 10 is located, to improve the user experience.

In an embodiment, as shown in FIG. 8, length D2 of the first mounting region S1 (length in a left-right direction shown in FIG. 8) is less than a second preset value, and width D1 of the first mounting region S1 (length in an up-down direction shown in FIG. 8) is less than a third preset value. Specifically, area of the first mounting region S1 should not be excessively large to meet arrangement compactness of the steam hole 11A and the externalization assembly 122. As an example, length of the pot lid 10 is L1 and width of the pot lid 10 is L2, and the length D2 of the first mounting region S1 is less than or equal to 0.8*L2, and the width D1 of the first mounting region S1 is less than or equal to 0.5*L1. Arrangement of the steam hole discharging steam and the externalization assembly is more compact by limiting size of the first mounting region S1.

The lid body assembly according to the disclosure includes a pot lid and an air blowing device, the pot lid is provided with a first mounting region, a steam hole discharging steam is arranged in the first mounting region, and an externalization assembly displaying the operation state of the airflow generation device is also arranged in the first mounting region. By arranging the steam hole and the externalization assembly in the same region, arrangement in their spatial structures is more compact, facilitating the user to observe steam discharging condition and the air exchange operation state of the cooking apparatus collectively, and improving the user experience.

In some embodiments, as shown in FIG. 11, the externalization assembly 122 includes a movement component 1221 and a transparent lid body 1222. The movement component 1221 is configured to move under driving of the airflow generated by the airflow generation device 21. Specifically, the movement component 1221 may be connected to the pot lid 10 directly or indirectly. An air duct is further formed in the externalization assembly 122 and communicated with an air duct of the airflow generation device 21. The air duct of the externalization assembly 122 may be an air duct which is formed from the externalization assembly 122 itself and completely independent of the pot lid 10, or may be partially formed from the pot lid 10. The movement component 1221 is arranged in the air duct of the externalization assembly 122, the airflow from the airflow generation device 21 may drive the movement component 1221 to move in the air duct of the externalization assembly 122, and specific forms of the movement may be rotation, swinging, floating, or the like. As an example, the movement component 1221 may be a fan blade or turbine rotatably connected to the pot lid 10, and the movement component 1221 may rotate relative to the pot lid 10 under driving of the airflow.

As shown in FIG. 11, the transparent lid body 1222 is arranged above the movement component 1221 to observe movement of the movement component 1221. Specifically, the user may observe a movement state of the movement component 1221 through the transparent lid body 1222. For example, when the user observes through the transparent lid body 1222 that the movement component 1221 is moving, it means that there is an airflow in the air duct of the externalization assembly 122, that is, the airflow generation device 21 is in an operation state and the cooking apparatus is in an air exchange state. When the user observes through the transparent lid body 1222 that the movement component 1221 does not move, it means that the airflow generation device 21 does not operate, and the cooking apparatus does not perform air exchange. When the user observes through the transparent lid body 1222 that the movement component 1221 is rotating at a high speed, it means that the cooking apparatus is performing high-speed air exchange. When the user observes through the transparent lid body 1222 that the movement component 1221 is rotating at a low speed, it means that the cooking apparatus is performing low-speed air exchange. That is, the user may know the operation state of the cooking apparatus by directly observing the movement state of the movement component 1221 under the transparent lid body 1222.

As shown in FIG. 8, the externalization assembly 122 and the steam hole 11A are arranged in parallel in a first direction. Specifically, the pot lid 10 may be of a generally planar shape, and the first direction may be a direction generally parallel to the plane, that is, the externalization assembly 122 is generally flush with the steam hole 11A in a height direction (the up-down direction shown in FIG. 8). The first direction may be flexibly set according to actual requirements, which may be a width direction of the pot lid 10 (the left-right direction shown in FIG. 8), or may be a length direction of the pot lid 10 (the up-down direction shown in FIG. 8), or may be a diagonal direction of the pot lid 10. In one embodiment, the externalization assembly 122 and the steam hole 11A may be arranged in the width direction of the pot lid 10.

By arranging the externalization assembly in a specific structure including the movement component and the transparent lid body to indirectly display the operation state of the airflow generation device in a mechanical motion manner, it may determine the operation state of the cooking apparatus, and the arrangement provides a simple structure with high reliability.

In some embodiments, as shown in FIG. 11, an edge of the externalization assembly 122 and an edge of the steam hole 11A are in contact with each other in the first direction or spaced by a distance d less than a first preset value. Specifically, the edge of the externalization assembly 122 may be in contact with the edge of the steam hole 11A, and the externalization assembly 122 and the steam hole 11A occupy the smallest space in the first mounting region S1 and are arranged most compactly. Or, the externalization assembly 122 and the steam hole 11A may be arranged to be spaced apart from each other, and arrangement between the two components may meet compactness requirements, and a risk of steam discharged from the steam hole 11A entering the externalization assembly 122 may also be effectively reduced. The spacing distance d should not be excessively large, and as an example, the distance d is less than 20 mm. The externalization assembly and the steam hole are arranged in the first mounting region more compactly by limiting the distance between the externalization assembly and the steam hole in the first direction.

In some embodiments, the externalization assembly 122 is a part of structure of the pot lid 10 itself, that is, the externalization assembly 122 is partially formed from the pot lid 10. Specifically, as shown in FIG. 11, a first accommodation cavity 11B accommodating the movement component 1221 is formed in the pot lid 10. The pot lid 10 may be recessed toward a cavity to form the first accommodation cavity 11B with an end opening, and the movement component 1221 may be taken out and put in through the opening. The transparent lid body 1222 is fixedly connected to the pot lid 10 to close the end opening of the first accommodation cavity 11B. Specifically, the transparent lid body 1222 closes the opening, the first accommodation cavity 11B may be the air duct of the externalization assembly 122 and communicated with the air duct of the airflow generation device 21, and airflow from the air duct of the airflow generation device 21 is blown into the first accommodation cavity 11B, to drives the movement component 1221 arranged in the first accommodation cavity 11B to move. That is, the steam hole and the first accommodation cavity with an end opening are formed from the structure of the pot lid itself, and components of the lid body assembly may be effectively reduced, and structure thereof is simplified.

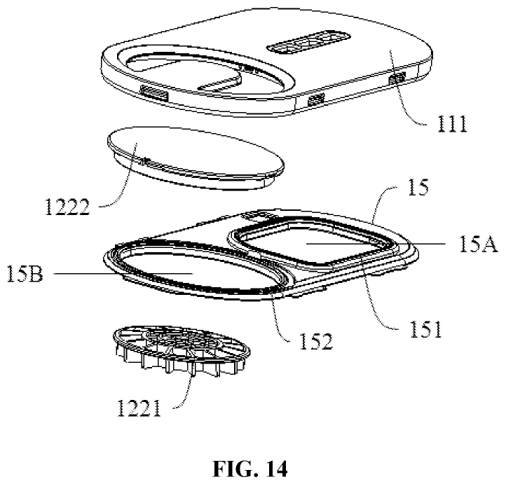

In an embodiment, as shown in FIG. 11 and FIG. 14, the lid body assembly further includes a sealing and isolation member 15 to isolate the steam hole 11A from the first accommodation cavity 11B. Specifically, with sealing and isolation effects of the sealing and isolation member 15, a risk of steam coming out of the steam hole 11A entering the first accommodation cavity 11B may be effectively reduced, and operation stability and reliability of the lid body assembly are improved.

In an embodiment, as shown in FIG. 11 and FIG. 14, the sealing and isolation member 15 is provided with a first opening 15A and a second opening 15B spaced apart from each other. Specifically, the first opening 15A is communicated with the steam hole 11A correspondingly, and the second opening 15B is communicated with the first accommodation cavity 11B correspondingly. A first rib 151 is formed by protruding from a wall surface of the sealing and isolation member 15 adjacent to the first opening 15A, and a second rib 152 is formed by protruding from a wall surface of the sealing and isolation member 15 adjacent to the second opening 15B, here an outer edge of the steam hole 11A abuts against the first rib 151, and an outer edge of the first accommodation cavity 11B abuts against the second rib 152. Specifically, a steam valve cap 16 may be arranged on the sealing and isolation member 15, covers the sealing and isolation member 15 and abuts against the two ribs of the sealing and isolation member 15. The steam valve cap 16 is connected to the pot lid 10, and the sealing and isolation member is provided with the ribs, further improving sealing effect.

In some other embodiments, the externalization assembly 122 is independent of the structure of the pot lid 10 itself. Specifically, as shown in FIG. 11, the externalization assembly 122 includes a shell 1223, in which a second accommodation cavity 122A accommodating the movement component 1221 is formed. Specifically, the shell 1223 encloses the second accommodation cavity 122A with an end opening, the shell 1223 is fixedly connected to the pot lid 10, here “fixedly connected” may be bonding, snap-in connection, fastener connection, or the like, and the shell 1223 is supported and positioned by the pot lid 10. The transparent lid body 1222 is connected to the shell 1223 to close the end opening of the second accommodation cavity 122A. A complete structure of the externalization assembly may be formed by the shell, the movement component and the transparent lid body. Compared to an integrally formed arrangement, the structure is more flexible in arrangement and facilitates replacement of components.

In some other embodiments, as shown in FIG. 13, the lid body assembly further includes a venting member 14. Specifically, the venting member 14 may be an independent steam valve and provided with a steam channel 141 discharging steam, here a valve spool may be or may not be arranged in the steam channel 141. The venting member 14 is at least partially arranged in the steam hole 11A. The venting member 14 may be completely arranged in the steam hole 11A, or may be partially arranged in the steam hole 11A. Steam in the cooking cavity 10a may be discharged through the steam channel 141 of the venting member 14. In an embodiment, the venting member 14 may be detachably connected to the pot lid 10, facilitating replacement of the venting member 14.

The venting member 14 and the externalization assembly 122 are integrated into a unitary member. Specifically, in case that both the externalization assembly 122 and the venting member 14 are independent of the pot lid 10, the externalization assembly 122 and the venting member 14 may be integrated into a single component, that is, the externalization assembly 122 and the venting member 14 are used as parts of the unitary member, further making arrangement of the components more compact and coordinated.

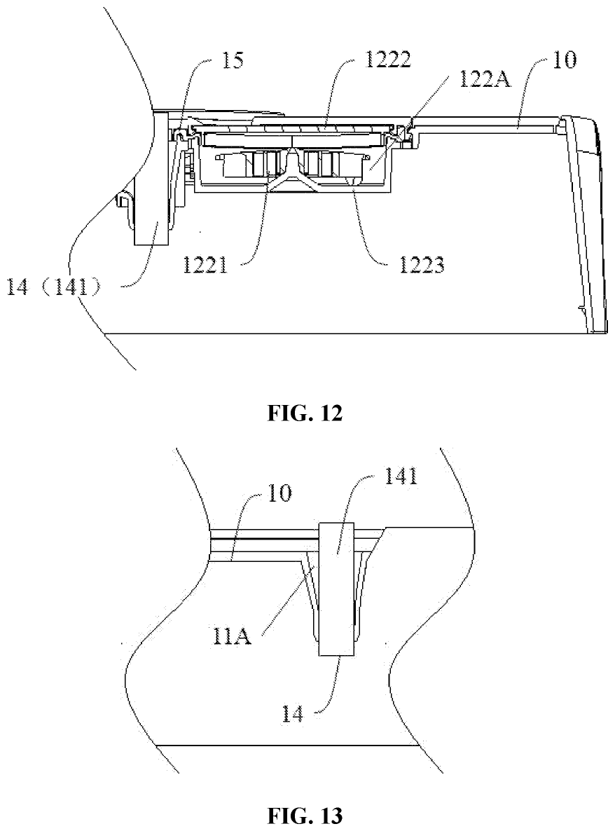

In some embodiments, as shown in FIG. 12 and FIG. 14, the unitary member further includes a sealing and isolation member 15 arranged between the venting member 14 and the shell 1223 to isolate the second accommodation cavity 122A from the steam channel 141. Specifically, the sealing and isolation member 15 may play a role of sealing and isolation. As an example, the sealing and isolation member 15 may be a sealing and isolation silica gel. By arranging the sealing and isolation member 15 between the venting member 14 and the shell 1223, a risk of steam coming out of the steam channel 141 entering the second accommodation cavity 122A may be effectively reduced, and operation stability and reliability of the lid body assembly are improved.

In some embodiments, as shown in FIG. 14, the sealing and isolation member 15 is provided with a first opening 15A and a second opening 15B spaced apart from each other. Specifically, the venting member 14 is arranged corresponding to position of the first opening 15A, and the externalization assembly 122 is arranged corresponding to position of the second opening 15B. A first rib 151 is formed by protruding from a wall surface of the sealing and isolation member 15 adjacent to the first opening 15A and abuts against an outer edge of the steam channel 141, and a second rib 152 is formed by protruding from a wall surface of the sealing and isolation member 15 adjacent to the second opening 15B and abuts against an outer edge of an opened end of the second accommodation cavity 122A of the shell 1223. A steam valve cap 16 may further be arranged on the sealing and isolation member 15, covers the sealing and isolation member 15 and abuts against the two ribs of the sealing and isolation member 15. The steam valve cap 16 is connected to the pot lid 10, the sealing and isolation member is arranged in an integrally formed structure and is provided with separate openings to limit the steam channel and the externalization assembly in the first mounting region, and the sealing and isolation member is provided with the ribs, further improving sealing effect.

An embodiment of the disclosure provides a cooking apparatus, as shown in FIG. 1, including a pot body 2 and the lid body assembly according to any one of the above embodiments. The pot body 2 is provided with a cooking cavity 10; the lid body assembly covers the pot body 2 to open or close the cooking cavity 10a, and the air blowing device 20 of the lid body assembly is communicated with the cooking cavity 10a to blow air into the cooking cavity 10a. Fresh air is blown into the cooking cavity by means of air blowing, and a flow direction of the air is controlled by means of the check valve, and air inflow is separated from air outflow, and controlling of blowing air into the cooking apparatus is simplified. The flow direction of the air is controlled, and air inflow is separated from air outflow, and controlling of blowing air into the cooking apparatus is simplified.

The above descriptions is only some embodiments of the disclosure, however, the scope of protection of the disclosure is not limited thereto. Any changes or substitutions which may be easily conceived by those skilled in the art within the scope disclosed in the disclosure, shall fall within the scope of protection of the disclosure. Therefore, the scope of protection of the disclosure shall be subject to the scope of protection of the claims.

1. A lid body assembly, comprising:
a pot lid, configured to cover a pot body provided with a cooking cavity to open or close the cooking cavity;
an air blowing device, arranged in the pot lid and configured to blow air into the cooking cavity; and
a check valve, configured to unidirectionally guide an airflow to flow from the air blowing device to the cooking cavity.

2. The lid body assembly of claim 1, wherein the air blowing device comprises:
an airflow generation device, configured to generate an airflow; and
an air inlet device, connected to the airflow generation device to introduce the airflow, and connected to the check valve to enable the airflow in the air inlet device to flow to the cooking cavity unidirectionally.

3. The lid body assembly of claim 2, wherein the check valve is arranged at an outlet end of the air inlet device.

4. The lid body assembly of claim 3, wherein the pot lid comprises:
a surface lid, on which the air inlet device is mounted; and
an inner lid, connected to the surface lid, the check valve being fixed on the inner lid.

5. The lid body assembly of claim 3, wherein the pot lid comprises:
a surface lid, on which the air inlet device is mounted;
an inner lid, adjacent to and connected to the surface lid, and provided with a first channel penetrating through opposite ends of the inner lid;
a movable cover plate, arranged on a side of the inner lid away from the surface lid, connected to the inner lid, and provided with a first through hole communicated with the first channel; and
a first sealing member, arranged between the inner lid and the movable cover plate around the first through hole,
wherein the check valve is at least partially arranged in the first channel, or the check valve is at least partially arranged in the first through hole.

6. The lid body assembly of claim 4, wherein the check valve comprises:
a valve seat, provided with a second through hole communicated with the air inlet device; and
a valve body, connected to the valve seat and configured to open or close the second through hole unidirectionally.

7. The lid body assembly of claim 6, wherein the valve body comprises:
a connection part, configured to penetrate through the valve seat and connected to the valve seat; and
a movable part, arranged around the connection part, shielding the second through hole, and capable of being in contact with or not in contact with the valve seat to open or close the second through hole.

8. The lid body assembly of claim 7, wherein thickness of the movable part is 0.3 to 1 mm;
and/or,
width of the movable part is 8 to 35 mm;
and/or,
hardness of the movable part is 20 to 50 HB.

9. The lid body assembly of claim 7, wherein the movable part comprises:
a valve plate, fixed at an end of the connection part, surrounding the connection part, and configured to shield the second through hole; and
a skirt, arranged at an edge of the valve plate and configured to be in contact with or not in contact with the valve seat, wherein a sectional area of the skirt decreases from an end in contact with the valve plate to another end in contact with the valve seat, wherein an included angle between an extension direction of the skirt and an extension direction of the valve plate is greater than a preset value,
wherein the valve seat comprises,
a seat body, provided with the second through hole, the connection part of the valve body penetrating through the seat body, the valve plate of the valve body located on a side of the seat body away from the surface lid, and the skirt being close to the seat body compared to the valve plate; and
a fixed part, arranged at an edge of the seat body, wherein the fixed part is provided with a second sealing member forming a seal with the surface lid.

10-12. (canceled)

13. The lid body assembly of claim 6, wherein a sectional area of the second through hole decreases in a direction from the surface lid to the inner lid.

14. The lid body assembly of claim 2, wherein the pot lid is provided with a first mounting region, in which a steam hole discharging steam is arranged; and the air blowing device further comprises:
an externalization assembly, configured to display the airflow and arranged in the first mounting region; and
an air guide component, configured to guide the airflow out of the pot lid.

15. The lid body assembly of claim 14, wherein the externalization assembly comprises:
a movement component, configured to move under driving of the airflow generated by the airflow generation device; and
a transparent lid body, arranged above the movement component to observe movement of the movement component,
wherein the externalization assembly and the steam hole are arranged in parallel in a first direction, wherein an edge of the externalization assembly and an edge of the steam hole are in contact with each other in the first direction or spaced by a distance less than a first preset value.

16. (canceled)

17. The lid body assembly of claim 15, further comprising a sealing and isolation member to isolate the steam hole from a first accommodation cavity,
wherein the first accommodation cavity accommodating the movement component is formed in the pot lid, and the transparent lid body is fixedly connected to the pot lid to close an end opening of the first accommodation cavity, and
wherein the sealing and isolation member is provided with a first opening and a second opening spaced apart from each other, a first rib is formed by protruding from a wall surface of the sealing and isolation member adjacent to the first opening, and a second rib is formed by protruding from a wall surface of the sealing and isolation member adjacent to the second opening, wherein an outer edge of the steam hole abuts against the first rib, and an outer edge of the first accommodation cavity abuts against the second rib.

18. (canceled)

19. (canceled)

20. The lid body assembly of claim 15, wherein the externalization assembly further comprises: a shell in which a second accommodation cavity accommodating the movement component is formed, the transparent lid body connected to the shell to close an end opening of the second accommodation cavity, wherein the externalization assembly is fixedly connected to the pot lid.

21. The lid body assembly of claim 14, further comprising:
a venting member, at least partially arranged in the steam hole, and internally provided with a steam channel discharging steam,
wherein the venting member and the externalization assembly are integrated into a unitary member.

22. The lid body assembly of claim 21, wherein the unitary member further comprises a sealing and isolation member arranged between the venting member and the externalization assembly to isolate the externalization assembly from the steam channel wherein the sealing and isolation member is provided with a first opening and a second opening spaced apart from each other, a first rib is formed by protruding from a wall surface of the sealing and isolation member adjacent to the first opening, and a second rib is formed by protruding from a wall surface of the sealing and isolation member adjacent to the second opening, wherein an outer edge of the steam channel abuts against the first rib, and an outer edge of the externalization assembly abuts against the second rib.

23. (canceled)

24. The lid body assembly of claim 21, wherein the venting member is detachably connected to the pot lid.

25. The lid body assembly of claim 15, wherein the first direction is a width direction of the pot lid.

26. The lid body assembly of claim 14, wherein a ratio of a size of the first mounting region in a depth direction of the pot lid to a depth of the pot lid is less than 0.5, and a ratio of a size of the first mounting region in a width direction of the pot lid to a width of the pot lid is less than 0.8.

27. A cooking apparatus, comprising:
a pot body, provided with a cooking cavity; and
a lid body assembly, comprising:
a pot lid, configured to cover a pot body provided with a cavity to open or close the cooking cavity;
an air blowing device, arranged in the pot lid and configured to blow air into the cooking cavity; and
a check valve, configured to unidirectionally guide an airflow to flow from the air blowing device to the cooking cavity, covering the pot body to open or close the cooking cavity, and the air blowing device of the lid body assembly communicated with the cooking cavity to blow air into the cooking cavity and guide air out of the cooking cavity.
